(19) United States
(12) Patent Application Publication
(10) Pub. No.: US 2006/0069195 A1
(43) Pub. Date: Mar. 30, 2006

(54) Storage stable liquid organotinthioalkanol PVC stabilizer

(75) Inventor: Henry J. Barda, North Brunswick, NJ (US)

Correspondence Address: AKZO NOBEL INC.;INTELLECTUAL PROPERTY DEPARTMENT, 7 LIVINGSTONE AVENUE, DOBBS FERRY, NY, 10522-3408, US

(73) Assignee: AKZO NOBEL N.V., Arnhem (NL)

(21) Appl. No.: 11/232,664

(22) Filed: Sep. 22, 2005

Related U.S. Application Data
(60) Provisional application No. 60/613,961, filed on Sep. 28, 2004.

(51) Int. Cl. C08K 5/05

(52) U.S. Cl. 524/381

(57) ABSTRACT

The invention comprises a method for preparing a stabilizer comprising organotinthioalkanol comprising reacting the ingredients in a mixture comprising both alkyltin and dialkyltin containing compounds, a thioalkanol, an additional sulfur containing compound and optionally an oxygen containing compound. The amount of thioalkanol in the composition is limited to no more than about 0.5000 equivalent per equivalent of the alkyltin and dialkyltin containing compounds. There is also present from about 1 percent by weight to about 50 percent by weight, based on the weight of the organotinthioalkanol stabilizer of a low volatility, low water solubility, aliphatic hydroxyl-containing, liquid organic compound that is introduced into the reaction mixture following completion of the reaction. The invention includes the organotinthioalkanol stabilizer made by the above method.

### CROSS REFERENCE TO RELATED APPLICATION

Priority of this application is based on Provisional Application Ser. No. 60/613,961, filed Sep. 28, 2004, the entire content of which is incorporated herein.

### BACKGROUND OF THE INVENTION

1. Field of the Invention

This invention relates to organotinthioalkanol stabilizers.

2. Prior Art

U.S. Pat. No. 5,109,046, which is incorporated herein in its entirety, describes the tendency for liquid organotinthioalkanol stabilizer compositions to exhibit poor storage stability as manifested by heterogeneity. That patent advocates the presence of certain defined amounts of bound chlorine and of free mercaptan in order to retard such heterogeneity. However, bound chlorine can cause the corrosion of processing equipment and of storage containers. Furthermore, reports by certain users indicate that a commercial stabilizer, which has essentially the composition of Example 14 in that patent, does not have the desired storage stability.

U.S. Pat. No. 4,059,562 teaches the inclusion of a glycol and of an alkyl acid phosphate to solve the same problem. The inclusion of these water soluble ingredients leads to another problem, namely, a decrease in water resistance for such a composition.

U.S. Pat. No. 5,567,751 teaches the inclusion of an aromatic ether alcohol and an alkylphenol as another method of improving the shelf stability of organotinthioalkanol compositions. The presence of alkylphenols of the type claimed, in polyvinyl chloride compositions, is known to decrease the light stability of said compositions thus making them unsuitable for many uses.

A novel organotinthioalkanol stabilizer, substantially free of these problems, and with excellent storage stability has been found.

### SUMMARY OF THE INVENTION

In one embodiment, the invention comprises a method for preparing a stabilizer comprising organotinthioalkanol comprising reacting the ingredients in a mixture comprising both alkyltin and dialkyltin containing compounds, a thioalkanol, an additional sulfur containing compound and optionally an oxygen containing compound. The amount of thioalkanol in the composition is limited to no more than about 0.5000 equivalent per equivalent of the alkyltin and dialkyltin containing compounds. There is also present from about 1 percent by weight to about 50 percent by weight, based on the weight of the organotinthioalkanol stabilizer of a low volatility, low water solubility, aliphatic hydroxyl-containing, liquid organic compound that is introduced into the reaction mixture following completion of the reaction.

A preferred embodiment of the invention is a method of preparing a stabilizer comprising a mixture of organotinthioalkanol, an organotin sulfide, an organotin mercaptide and optionally an organotin carboxylate comprising reacting the ingredients in a mixture comprising both alkyltin and dialkyltin chlorides, a sulfide, mercaptan, a thioalkanol, a base and optionally a carboxylic acid. The amount of thioalkanol in the composition is limited to no more than about 0.5000 equivalent per equivalent of the alkyltin and dialkyltin containing compounds. There is also present from about 1 percent by weight to about 50 percent by weight, based on the weight of the organotinthioalkanol stabilizer of a low volatility, low water solubility, aliphatic hydroxyl-containing, liquid organic compound introduced into the reaction mixture following completion of the reaction. In a second embodiment, the invention comprises the organotinthioalkanol stabilizer made by the above method.

Other embodiments of the invention relate to details concerning reactants employed in the above method. All of which are hereinafter described.

### DETAILED DESCRIPTION OF THE INVENTION

The alkyltin and dialkyltin containing compounds that could be used in the process of the invention preferably comprise,but are not limited to chlorides, hydroxides and oxides. Another class of raw materials used in the process of the invention comprise sulfides, mercaptans, and carboxylic acids, compounds capable of introducing sulfur and/or oxygen ligands (groups) into the organotin compounds which result in organotin products with heat stabilizing properties.

Organotin raw materials: The most preferred organotin raw material is a mixture of alkyltin chlorides: RSnCl₃/R₂SnCl₂. A commercially viable, alternative raw material is the hydrolysis product of the chlorides: RSn(O)OH/R₂SnO. These hydrolysis products, however, have a limitation: they do not react with sulfides, such as sodium sulfide, to give organotin sulfides, one of the desirable components in a stabilizer. There are, theoretically, other possible organotin raw materials, however, they are commercially irrelevant. Viable organotin raw materials do not include those containing sulfur.

Raw materials for inclusion in the reaction mixture that may be used for introducing oxygen and sulfur ligands (groups) into the organotin raw materials to give products with stabilizing properties may be of two types. The first type can be represented by LH, where L is a ligand. This can be mercaptans (R′SH), for introduction of the sulfur ligand, or carboxylic acids (R′CO₂H) for introduction of the optional oxygen ligand.

The second type raw material for introduction of the sulfur ligand is a sulfide represented by M₁₋₂S, where M is a metal ion, and exemplified by Na₂S.

LH raw materials react with organotin chloride raw materials only in the presence of a base, such as sodium hydroxide, but react with their hydrolysis products without a base. Sulfides react with organotin chlorides (without the presence of base), but do not react with the hydrolysis products of chlorides. In other words, if one wants an organotin sulfide in the product mixture, then it is necessary to have at least part of the organotin raw material as an organotin chloride.

The alkyl constituent of the alkyltin and dialkyltin may comprise from C₁-C₈. The preferred alkyl is butyl.

The organotin sulfides, organotin mercaptides and/or organotin carboxylates, the constituents of the organotinthioalkanol stabilizer, may be formed in the reaction mixture of alkyltin chloride and dialkyltin chloride with a mixture of mercaptan, sulfide, and optionally carboxylic acid. Alternately, the organotinthioalkanol stabilizer may be formed in the reaction mixture of the hydrolysis products of alkyltin chloride and dialkyltin chlorides, namely organotin hydroxides and oxides, with a mixture of mercaptan, sulfide, and optionally carboxylic acid, and an amount of alkyltin chloride and dialkyltin chloride equivalent to the sulfide.

The most preferred organotin raw material for use in regard to the present invention is an equilibrium mixture of about 60 weight percent butyltin trichloride and about 40 weight percent dibutyltin dichloride (or the equivalent hydrolysis products thereof, namely, their oxides and hydroxides). In practice, such mixtures preferably contain anywhere from about 64 weight percent of butyltin trichloride and about 36 weight percent of dibutyltin dichloride to about 54 weight percent of butyltin trichloride and about 46 weight percent of dibutyltin dichloride. The widest range that generally can be used varies from about 10 weight percent of butyltin trichloride and about 90 weight percent of dibutyltin dichloride to about 90 weight percent butyltin trichloride and about 10 weight percent dibutyltin dichloride. Equivalent mixtures of other alkyltin chlorides, such as methyltins and octyltins can also be used.

There are many thioalkanols that would be effective for use in the process of the invention (e.g. 3-mercaptopropanol), but for commercial reasons, the preferred thioalkanol is 2-mercaptoethanol. For every equivalent of organotin chloride (or equivalent hydrolysis product) from about 0.1000 to about 0.5000 equivalent of thioalkanol can be used. The most preferred range varies from about 0.1500 to about 0.2000 equivalent of thioalkanol per organotin chloride equivalent.

The hydroxyl-containing organic compound functions as a non-reactive diluent and has low volatility and low water solubility. The compound is aliphatic and can have from about 4 to about 69 carbon atoms, can be saturated or unsaturated, and can contain one or more hydroxyl groups, as well as contain other functional groups such as carboxylic acids or carboxylic esters. The purpose of the diluent is to improve the storage stability of the organotinthioalkanol heat stabilizer composition. It is essentially a solvent which does not participate in the chemical reaction, and is introduced into the reaction mixture after the chemical reactions are completed. It can be present in the about 1% to about 50% range, based on the weight of the stabilizer product.

The most preferred diluent is castor oil, which contains both hydroxyl and ester groups. Other preferred compositions are ricinoleic acid, castor oil acids, oleyl alcohol, and mixtures of alcohols that have from about 12 to about 16 carbon atoms. The volatility and water solubility of the diluent used will be on the order of that of those compositions, although one of ordinary skill in the art would know which composition to employ where particular volatility and/or water solubility are desired in a particular situation.

U.S. Pat. No. 5,567,751, in contradistinction to the invention, teaches the use of a mixture of aromatic ether alcohol and alkylated phenol as the non-reactive diluent, rather than aliphatic as required by the invention. Furthermore, the presence of alkylated phenols, which oxidize easily to generate colored products, leads to PVC formulations which weather poorly. That is to say, objects made from these formulations change color with time when exposed to sunlight and the outdoors.

U.S. Pat. No. 4,059,562 teaches the use of a mixture of a glycol and an alkyl acid phosphate as the non-reactive diluent. Both these classes of compounds are water soluble. The presence of water soluble ingredients in PVC formulation leads to a decrease in water resistance. That is to say, objects made from these formulations deteriorate faster when exposed to rain and moisture in the outdoors.

Other reactants in the composition, beside thioalkanols, may include one or more of the non-hydroxyl-containing mercaptans, sulfides, and carboxylic acids. Suitable mercaptans include the alkyl mercaptans, such as dodecyl mercaptan, the esters of 2-mercaptoacetic acid, such as 2-ethylhexyl 2-mercaptoacetate, the esters of 3-mercaptopropionic acid, such as dodecyl 3-mercaptopropionate, and the 2-mercaptoethyl carboxylates, such as 2-mercaptoethyl oleate and 2-mercaptoethyl octanoate. Suitable carboxylic acids include 2-ethylhexanoic acid, dodecanoic acid, and oleic acid. Suitable bases include alkali metal bases, such as sodium hydroxide.

Sulfides, mercaptides and/or carboxylates may be formed in-situ in the reaction mixture by reacting a mixture of alkyltin trichloride and dialkyltin dichloride with mercaptan, sulfide and, optionally, carboxylic acid, and an amount of base equivalent to the combined mercaptan and carboxylic acid. Alternatively, the reaction mixture may comprise the hydrolysis products of alkyltin trichloride and dialkyltin dichloride with mercaptan, sulfide and optionally carboxylic acid, and an amount of a mixture of butyltin trichloride and dibutyltin dichloride equivalent to the sulfide.

The following Examples further illustrate certain preferred embodiments of the present invention.

### EXAMPLE 1

A summary of the reaction mixture of this example is as follows:

| | | | | Equivalent/ |
|---|---|---|---|---|
| | | | | Equivalent |
| | g | Eq.wt. | Equivalents | Cl |
| Water | 145.1 | — | — | — |
| 2-Mercaptoethanol | 31.2 | 78.1 | 0.3995 | 0.1744 |
| n-Dodecyl mercaptan | 165.2 | 202.4 | 0.8162 | 0.3564 |
| Mixed butyltin | 255.3 | 111.48 | 2.2901 | 1.0000 |
| chlorides, 31.8% Cl | | | | |
| Sodium hydroxide, | 214.5 | 200.0 | 1.0725 | — |
| 20% | | | | |
| Sodium sulfide, 60% | 71.4 | 65.0 | 1.0958 | 0.4785 |
| Sodium hydroxide, | about 24.4 | 200.0 | 0.1218 | — |
| 20% | | | | |

A 1-liter, 4-neck flask was equipped with a mechanical stirrer, sub-surface thermometer, and addition funnel. To the flask was added water, 2-mercaptoethanol, n-dodecyl mercaptan, and mixed butyltin chlorides. With stirring and cooling, the first sodium hydroxide charge was added incrementally to a maximum temperature of 54° C. The mixture was stirred for thirty minutes. The sodium sulfide was added incrementally to a maximum temperature of 84° C. The resulting mixture was then stirred for an additional thirty minutes. The second sodium hydroxide charge was gradually added to a pH end point of 6.6. The content was transferred to a separatory funnel heated to 85° C. The phases were allowed to separate. The bottom aqueous phase was drained and was discarded. The product phase was transferred back to the flask where it was dehydrated by heating under reduced pressure. The hot product was then vacuum filtered through a layer of diatomaceous earth. Analysis was as follows: 27.34% tin, 19.47% sulfur (reported as mercaptan), under 40 ppm chloride.

Although not intended to be limiting, the relevant chemical reactions believed to occur in Example 1 are:
RSnCl₃+3 LH+3 NaOH→RSnL₃+3 H₂O+3 NaCl
R₂SnCl₂+2 LH+2 NaOH→R₂SnL₂+2 H₂O+2 NaCl
RSnCl₃+1.5 M₂S→RSnS_{3/2}+3 MCl
R₂SnCl₂+M₂S→R₂SnS+2 MCl

### EXAMPLE 2

A summary of the reaction mixture of this example is as follows:

| | | | | Equivalent/ |
|---|---|---|---|---|
| | | | | Equivalent |
| | g | Eq.wt. | Equivalents | Cl |
| Water | 100.2 | — | — | — |
| 2-Mercaptoethanol | 60.7 | 78.1 | 0.7767 | 0.3386 |
| n-Dodecyl mercaptan | 157.2 | 202.4 | 0.7767 | 0.3386 |
| Mixed butyltin | 227.7 | 111.48 | 2.2937 | 1.0000 |
| chlorides. 31.8% Cl | | | | |
| Sodium hydroxide, | 273.1 | 200.0 | 1.3653 | — |
| 20% | | | | |
| Sodium sulfide, 60% | 48.9 | 65.0 | 0.7767 | 0.3386 |
| Sodium hydroxide, | about 30.3 | 200.0 | 0.1517 | — |
| 20% | | | | |

The procedure was essentially the same as in Example 1 except that the second sodium hydroxide charge was gradually added to a pH end point of 6.3. Analysis was as follows: 26.67% tin, 18.62% sulfur (reported as mercaptan), below 0.1% chloride.

### EXAMPLE 3

### Based on Example 1 in U.S. No. Pat. 5,109,046

A summary of the reaction mixture of this example is as follows:

| | | | | Equivalent/ |
|---|---|---|---|---|
| | g | Eq.wt. | Equivalents | Equivalent Cl |
| Water | 255.48 | — | — | — |
| n-Dodecyl mercaptan | 162.19 | 202.4 | 0.8013 | 0.3337 |
| 2-Mercaptoethanol | 63.01 | 78.1 | 0.8068 | 0.3360 |
| Butyltin trichloride | 225.98 | 94.1 | 2.4015 | 1.0000 |
| Sodium hydroxide, | 311.11 | 200.0 | 1.5556 | — |
| 20% | | | | |
| Sodium sulfide, 60% | 53.20 | 65.0 | 0.8185 | 0.3408 |
| Sodium hydroxide, | 3.00 | 200.0 | 0.0150 | — |
| 20% | | | | |

The procedure was essentially the same as in Example 1 except that butyltin trichloride was added instead of mixed butyltin chlorides, the pH end point was 4.9. Analysis was as follows: 25.74% tin, 20.42% sulfur (reported as mercaptan), under 0.1% chloride.

In Examples 1-3 at the end of the reactions two phases resulted: an aqueous phase containing mostly water and sodium chloride and a product phase. In Examples 1 and 2 the product phase was less dense than the aqueous phase and, therefore, became the top phase. In Example 3 the product phase was the most dense and, therefore, was at the bottom.

Examples 4-11 present the results of the use of Examples 1-3 in stabilizer formulations, with and without hydroxyl-containing liquid organic compounds, and the testing of the formulations by observing the number of days until a haze appears in the formulation. Tables I, II and III present a summary of the results.

TABLE I

Example

| | 4 | 5 |
|---|---|---|
| Product of Ex. 1, wt. % | 100 | 95.8 |
| Castor oil, wt. % | — | 4.2 |
| Days to haze | <1 | >30 |

TABLE II

Example

| | 6 | 7 |
|---|---|---|
| Product of Ex. 2, wt. % | 100 | 95.1 |
| Castor oil, wt. % | — | 4.9 |
| Days to haze | <1 | 1 |

TABLE III

Example

| | 8 | 9 | 10 | 11 |
|---|---|---|---|---|
| Product of Ex. 3, wt. % | 100 | 97.2 | 95.3 | 93.4 |
| Castor oil, wt. % | — | 2.8 | 4.7 | 6.6 |
| Days to haze | <1 | <1 | <1 | <1 |

Samples weighing 20 g of the compositions, as described in Examples 4 to 11, were added to 4 ounce jars, a bar magnet was added to each jar, and the jars were separately inserted into constant, 84% relative humidity chambers prepared according to ASTM E104 guidelines. The content of the jars was stirred magnetically while in the humidity chambers, which were kept at room temperature. The jars were inspected at least once daily, and the number of full days that the compositions were clear (or free of haze) was recorded as “days to haze”. Compositions that exhibited haze on the first day are recorded as “<1”.

Beside the product composition of the stabilizer, an important factor in storage stability is the physical response of the stabilizer to hydrolysis, namely, whether it remains homogeneous when exposed to moisture. Hydrolysis can take place during manufacture or during storage. During storage, the source of water can be residual water from manufacturing process or atmospheric humidity. In any case, the longer the stabilizer is clear or free of haze or is homogeneous upon exposure to moisture, the better is its storage stability.

The storage stability of the compositions that contained castor oil improved in the following order: Example Nos.9-11; (derived from Example 3); Example 7 (derived from Example 2); and Example 5 (derived from Example 1). Example 3 was based on the use of butyltin trichloride and contained more than 0.3000 equivalent of 2-mercaptoethanol per organotin chloride equivalent. Example 2 substituted a butyltin trichloride raw material for the mixed butyltin chloride reagent, but retained the level of 2-mercaptoethanol at more than 0.3000 equivalent per organotin chloride equivalent. On the other hand, Example 1 substituted both the butyltin trichloride raw material for the mixed butyltin chloride reagent, and lowered the level of 2-mercaptoethanol to less than 0.3000 equivalent per organotin chloride equivalent.

To summarize, it is apparent from Examples 4, 6 and 8 that the omission of the aliphatic hydroxyl-containing, liquid organic compound, i.e. castor oil, results in a stabilizer of low stability as indicated by days to haze of <1.

Examples 5 and 7 illustrate compositions of the invention, including both the low water solubility, aliphatic hydroxyl-containing, liquid organic compound and the mixed alkyltins. Those compositions show significantly higher Days to Haze.

1. A method of preparing a stabilizer comprising organotinthioalkanol comprising reacting the ingredients in a mixture comprising both alkyltin and dialkyltin containing compounds, a thioalkanol, an additional sulfur containing compound and optionally an oxygen containing compound, the amount of thioalkanol in the composition being limited to no more than about 0.5000 equivalent per equivalent of the alkyltin and dialkyltin containing compounds, and the presence of from about 1 percent by weight to about 50 percent by weight, based on the weight of said organotinthioalkanol stabilizer of a low volatility, low water solubility, aliphatic hydroxyl-containing, liquid organic compound introduced into the reaction mixture following completion of the reaction.

2. The method of claim 1 wherein said alkyltin compound and dialkyltin compound are selected from the group consisting of oxides, hydroxides and chlorides.

3. The method of claim 1 wherein said alkyltin compound and dialkyltin compound are chlorides, the additional sulfur containing compound is a mercaptan, the optional oxygen containing compound is carboxylic acid, and the reaction mixture includes a base.

4. The method of claim 1 wherein said additional sulfur containing compound is selected from the group consisting of sulfides and mercaptans and said oxygen containing compounds comprise carboxylic acids.

5. The method of claim 4. wherein said additional sulfur containing compound is a sulfide represented by M₁₋₂S, where M is a metal ion.

6. The method of claim 1 wherein the alkyls of said alkyltin compound and dialkyltin compound are C₁-C₈.

7. The method of claim 6 wherein the alkyl of said alkyltin compound and dialkyltin compound is butyl.

8. The method of claim 1 wherein said alkyltin and dialkyltin containing compounds are a mixture of butyltin trichloride and dibutyltin dichloride which comprise from about 10 weight percent of butyltin trichloride and about 90 weight percent of dibutyltin dichloride to about 90 weight percent of butyltin trichloride and about 10 weight percent of dibutyltin dichloride.

9. The method of claim 8 wherein said mixture of butyltin trichloride and dibutyltin dichloride comprise from about 64 weight percent of butyltin trichloride and about 36 weight percent of dibutyltin dichloride to about 54 weight percent of butyltin trichloride and about 46 weight percent of dibutyltin dichloride.

10. The method of claim 1 wherein for every equivalent of alkyltin and dialkyltin containing compounds there is from about 0.1000 to about 0.5000 equivalents of thioalkanol.

11. The method of claim 1 wherein for every equivalent of alkyltin and dialkyltin containing compounds there is from about 0.1500 to about 0.2000 equivalents of thioalkanol.

12. The method of claim 1 wherein said thioalkanol comprises 2-mercaptoethanol.

13. The method of claim 1 wherein said liquid organic compound is aliphatic, has from about 4 to about 69 carbon atoms, is saturated or unsaturated and contains one or more hydroxyl groups

14. The method of claim 1 wherein said liquid organic compound comprises carboxylic acids and/or carboxylic esters.

15. The method of claim 1 wherein said liquid organic compound is selected from the group consisting of castor oil, ricinoleic acid, castor oil acids, oleyl alcohol, and mixtures of alcohols which have from about 12 to about 16 carbon atoms.

16. The method of claim 15 wherein said liquid organic compound comprises castor oil.

17. The method of claim 4 wherein said mercaptans are selected from the group consisting of alkyl mercaptans, the esters of 2-mercaptoacetic acid, the esters of 3-mercaptopropionic acid, and the 2-mercaptoethyl carboxylates.

18. The method of claim 4 wherein said carboxylic acids are selected from the group consisting of 2-ethylhexanoic acid, dodecanoic acid and/or oleic acid.

19. An organotinthioalkanol stabilizer prepared by the method of claim 1.

20. A method of preparing a stabilized resin compositon, wherein a stabilizer is first prepared in accordance with claim 1 followed by a step where said stabilizer is added to a resin composition.

21. A resin composition comprising the stabilizer of claim 20.

22. A method of preparing a stabilizer comprising a mixture of organotinthioalkanol, an organotin sulfide, an organotin mercaptide and optionally an organotin carboxylate comprising reacting the ingredients in a mixture comprising both alkyltin and dialkyltin chlorides, a sulfide, mercaptan, a thioalkanol, a base and optionally a carboxylic acid, the amount of thioalkanol in the composition being limited to no more than about 0.5000 equivalent per equivalent of the alkyltin and dialkyltin containing compounds, and the presence of from about 1 percent by weight to about 50 percent by weight, based on the weight of said organotinthioalkanol stabilizer of a low volatility, low water solubility, aliphatic hydroxyl-containing, liquid organic compound introduced into the reaction mixture following completion of the reaction.
